(19) United States
(12) Patent Application Publication
(10) Pub. No.: US 2010/0236497 A1
(43) Pub. Date: Sep. 23, 2010

(54) System for controlling the interaction of animals and objects

(75) Inventors: Scott Philiben, Bend, OR (US); Bradley F. Blackwell, Huron, OH (US)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Precise Flight, Inc.

(21) Appl. No.: 11/477,192

(22) Filed: Jun. 27, 2006

Related U.S. Application Data
(60) Provisional application No. 60/695,976, filed on Jul. 1, 2005.

(51) Int. Cl. A01K 29/00

(52) U.S. Cl. 119/712

(57) ABSTRACT

The interaction of an animal and an object is controlled by causing a surface of the object to reflect light with a wavelength that induces a response by the animal.

### CROSS-REFERENCE TO RELATED APPLICATIONS

This application claims the benefit of U.S. Provisional Application No. 60/695,976, filed Jul. 1, 2005.

### STATEMENT REGARDING FEDERALLY SPONSORED RESEARCH OR DEVELOPMENT

Not applicable.

### BACKGROUND OF THE INVENTION

The present invention relates to a method for controlling animals and, more particularly, to a method for controlling the interaction of animals and other objects and structures.

Managing the interaction between animals and other objects in the environment has important commercial, environmental and social significance. For example, collisions between birds and aircraft occur wherever they share the same airspace. Between 1990 and 2003, over 52,000 collisions between wildlife and aircraft were reported to the U.S. Federal Aviation Administration (FAA); 97% of these incidents involved birds. A collision between a bird and an airplane is almost always fatal to the bird and the consequences to the aircraft depend, in part, on the relative sizes of the aircraft and the bird, the number of birds involved in the collision and the location of the strike on the aircraft. However, bird strikes present a serious hazard to aircraft and more than 130 people have been killed worldwide since 1995 as result of collisions between birds and aircraft. Assuming that 20% of wildlife-aircraft collisions are reported, the annual direct monetary losses and associated costs to U.S. civil aviation exceeds $500 million.

Various methods have been employed to reduce the hazard of collisions between animals and aircraft. Since most birds fly at low altitudes, typically less than a few hundred feet, about 80% of bird strikes on civilian aircraft occur during takeoff and landing and a number of tactics have been employed at airports to disperse or otherwise control birds and other animals. These methods may include selective hunting of problem species, however, in many cases the problem species is an internationally protected species and hunting is illegal. Non-lethal methods using frightening noises or sights can sometimes be used effectively in controlling transient migratory species, but the effectiveness of these techniques is usually short lived. Habitat modification, intended to deprive animals of food, shelter, space and water on or around airports, has been the most effective longer term tactic for reducing the population of animals sharing space with aircraft that are taxiing, taking-off and landing. While techniques that modify the airport environment can reduce the risk of colliding with an animal during taxiing, taking-off and landing, these methods are only partially effective and have a limited geographic range.

Collisions during the climb, cruise and descent portions of a flight are less likely than collisions during take-off and landing, but can be more hazardous because they often involve large soaring birds or migrating flocks of waterfowl. Aircraft-mounted bird strike avoidance systems address the risk of bird strikes both during portions of the flight when the aircraft is beyond the range of ground-based methods and during taxiing and low altitude flight supplementing ground-based animal management methods. For example, Steffen, U.S. Pat. No. 4,736,907, discloses an apparatus for preventing bird collisions comprising a plurality of lights that flash with continuously varying frequency. Increasing the frequency of light flashes has been found be more effective in causing an escape reaction in some birds and increasing the flash frequency for two separated light sources makes the aircraft appear to be moving closer at a high rate of speed increasing the acuteness of the animal's escape reaction. A microprocessor-based control permits storage of a plurality of flashing frequencies and cycles enabling selecting a light flashing routine appropriate to the speed of the plane if a collision hazard is anticipated. However, the flight crew must either locate and identify an animal hazard to the aircraft and select a light flashing pattern considered to appropriate to the identified hazard or initiate a light flashing pattern that is allowed to continue until a collision indicates that the selected flashing pattern is ineffective.

Philiben et al.; U.S. Pat. No. 6,940,424 B2; disclose a hazard avoidance system for a vehicle that utilizes data related to the location of a collision threat, conditions at the location of the collision threat and vehicle operating parameters to identify a potential animal hazard and select an optimal routine for illuminating a vehicle mounted light to repel the identified hazard. The hazard avoidance system may utilize lights that are installed on the vehicle specifically for the purpose of hazard avoidance or may utilize lights, such as aircraft landing lights, which are installed on the vehicle for another purpose. The system produces an output that is optimized to produce an avoidance response in the most likely animal threat to a vehicle that is moving through a constantly changing environment.

While flashing or pulsing lights provide a method of controlling the interaction of an animal and an object, these systems have characteristics which limit their effectiveness and desirability in many applications. Flashing light systems rely on the fixation of the animal with one or more point sources of light emissions and the effectiveness of the system is likely to be strongly influenced by the angle of approach of the animal to the object to which the light source is attached. For example, it may be difficult or impractical to provide light sources that are visible to animals that are free to approach a vehicle from a number of different directions. In other cases, for example, military aircraft, light emissions to protect the vehicle from bird strikes may facilitate human detection and exacerbate other hazards to the aircraft.

Managing the interaction of animals and many objects is also complicated by the size, construction and dispersal of the objects to be protected. For example, a structure such as a wind turbine or power transmission or communication tower may require a substantial array of flashing lights because of the size of the structure and many potential angles of approach to the object. Likewise, extensive arrays of flashing lights would be required to control interaction between birds and transmission lines, guy wires or crops because of the wide geographical dispersal of the objects to be protected. What is desired, therefore, is a non-lethal method of controlling the interaction of birds and other animals with objects that overcomes limitations or supplements the performance of animal management methods relying on point sources of light, noise and habitat modification.

### BRIEF DESCRIPTION OF THE DRAWINGS

FIG. 1 is a plot of the spectral probability of light absorption of a European starling.

FIG. 2 is a schematic illustration the system for managing the interaction of an animal and an object.

FIG. 3 is a block diagram of a data processing system for controlling an artificial light source.

FIG. 4 is a flow diagram for a method of managing the interaction of an animal and an object.

### DETAILED DESCRIPTION OF THE INVENTION

Managing the interaction between animals and other objects in the environment has important commercial, environmental and social significance. For example, wildlife damage to U.S. agriculture for 2001 has been estimated at $944 million. By way of additional examples, the annual cost to U.S. civil aviation of collisions between birds and aircraft is estimated to be in excess of $500 million per year and more than 130 people have been killed worldwide since 1995 as a result of bird strikes on civil aircraft. On the other hand, the consequences of a collision between a bird and an aircraft or other vehicle, wind turbine blade, power line or other object is in all likelihood very serious or fatal to the bird which may be a member of a protected or endangered species.

A number of strategies have been used to manage the interaction of animals and other objects in the environment. Lethal strategies, including hunting and poisoning, may be used to reduce populations of animals near airports, vulnerable crops and other areas where birds or other animals present a significant health or safety hazard or threat of economic loss. However, in many instances, the management effort may impact an endangered or protected species making lethal methods illegal. Moreover, large scale extermination of animals may be socially unacceptable even if the species is not protected. Non-lethal management strategies typically include the use of pyrotechnics, other noise-making devices and devices simulating the presence of predators, however, these methods often prove to be only temporarily effective. Habitat modification, intended to deprive animals of food, shelter, space and water has also been used to reduce the number of animals inhabiting airports or cropland. For example, herbicide use has been proposed to destroy cattails near sunflower fields to eliminate roosting areas for blackbirds and other species that threaten the crop. While habitat modification provides an effective longer term tactic for reducing the population of animals in an area that contains objects or structures to be protected, the elimination of significant areas of suitable habitat for animals may be environmentally undesirable or unacceptable. For example, wide spread habitat modification to protect crop land or wind turbine farms may have detrimental effects on many species.

Vision and, more specifically, the ability to discriminate between light of differing wavelengths or “color” vision is a primary sensory pathway for many animals. For example, many birds rely on color for determining the fitness of particular fruit and insects as food and light that includes specific wavelengths is integral to predator avoidance and communication with other members of the same species.

The production of a neural image for the light impinging on an animal begins with refraction to focus the light on the retina, a sheet of photoreceptors at the back of the eye. In terrestrial animals, most of the focusing takes place at the interface between the air and the cornea. Although the lens contributes to refraction, it serves mainly to provide fine adjustment during accommodation, the alteration of the refractive apparatus to maintain focus as the distance to an object changes.

Many of the complex functions of the visual system are accomplished in the retina. The retina senses light, integrates the information content of the light and passes the information to the brain in the form of nerve impulses. In most animals, the retina includes both rod and cone cells having segments containing photosensitive pigments that absorb light impinging on the cell. The rods are responsible for dim light or scotopic vision. The cones are responsible for bright light or photopic vision and enable color vision by mediating light according to its wavelength.

The photoreceptors of the retina transduce the intensity of impinging light into neurochemical signals that are passed along the optic nerve to the brain. The photoreceptors comprise large numbers of photopigment molecules which comprise a chromophore, a derivative of vitamin A, which is chemically bound to a protein called an opsin. When a photon is absorbed, the atoms of the chromophore are rearranged causing a change in the shape of the opsin which behaves as an enzyme producing the neurochemical signal. In most cases, all of the opsin molecules of a photoreceptor are identical and the photoreceptor has an absorption spectrum that is wavelength dependent. However, like a switch, the photopigment acts as a catalyst only when a photon is absorbed and any information about the spectral energy of an absorbed photon is discarded when it is absorbed by the photoreceptor. A single photoreceptor cannot convey information about the spectral energy distribution or “color” of light impinging upon it.

Animals extract information about the spectrum of light striking an area of the retina by contrasting the responses of photoreceptors containing different photopigments. Generally, an animal having a minimum of two separate classes of photoreceptors with different, but overlapping spectral sensitivities, has the ability to distinguish light of differing wavelengths. Human color vision is based on three color channels, each originating with the stimulation of one of three different types of photoreceptors.

In contrast, the retinas of most diurnal birds include a single class of rods, a single class of long-wavelength-sensitive, double cones and four classes of single cones. In addition, each of the class of cones includes an oil droplet arranged so that light must pass through the oil droplet to reach the photoreceptor. The oil droplets typically include a carotenoid pigment that acts as a long pass filter, transmitting light having a longer wavelength than a threshold wavelength and absorbing light having a shorter wavelength than the threshold. The spectral sensitivity of a avian cone cell is determined, generally, by the combination of the spectral transmission of the cell's oil droplet and the spectral absorbance of the cell's photopigment.

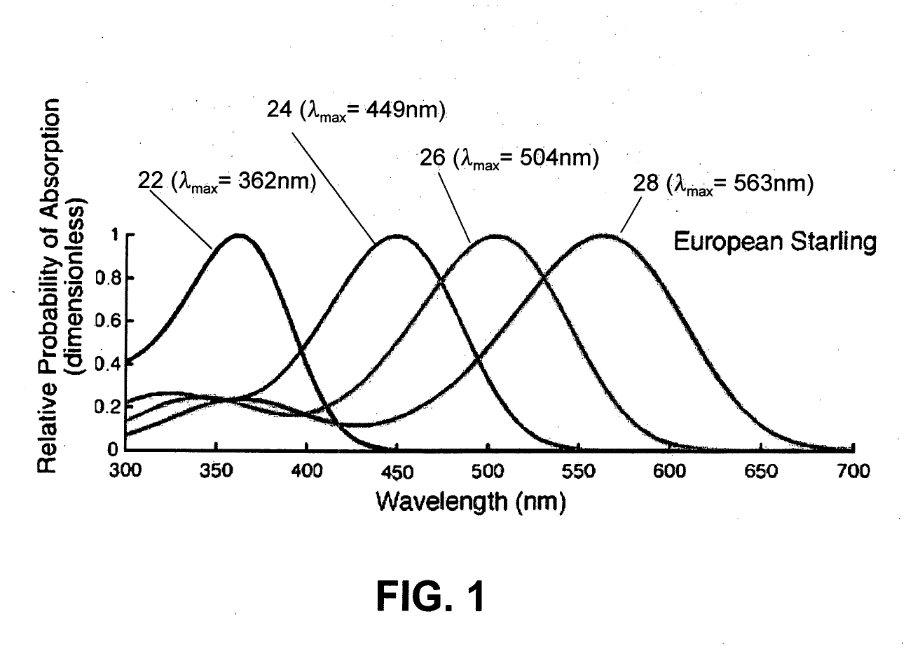

Referring to FIG. 1, spectrophotometric and electrophysiological studies of the avian retina indicate that birds can distinguish light with a wavelength ranging from approximately 325 nm (ultraviolet) through the range of wavelengths visible to humans (˜400-700 nm). While human color vision is based on three color channels, birds are generally considered to be tetrachromatic and some species may be pentachromatic. A tetrachromatic vision system can distinguish four primary colors: ultraviolet (UV) 22, blue 24, green 26 and red 28 corresponding to the peaks in the spectral absorption probability. In addition, the vision system can distinguish secondary colors resulting from mixtures of two neighboring primary colors: UV-blue, blue-green and green red; and non-spectral secondary colors: blue-red, UV-green and UV-red. Stimulation of three of the four color channels is also believed to produce a class of second-order mixed colors or ternary colors: UV-green-red, UV-green-blue, UV-blue-red and blue-green-red.

The relationship of the behavior of animals to the perception of light of a particular wavelength is influenced not only by the structure of the eye but also by the nature of the light and the effects of its passage through a medium in reaching the eye. For example, light is scattered by particles in the air, particularly by material that is small relative to the wavelength of the light, such as dust particles and molecules of oxygen and nitrogen. Since the wavelength of UV is shorter than the wavelength of light in the range of human vision, UV is scattered more by passage through the air and by chromatic aberration, the imperfections in the animal's ocular media. As a result, distant objects are more likely to appear indistinct when viewed with UV light. On the other hand, the light available near dawn and dusk comprises a greater proportion of UV and animals active at these times are particularly likely to rely on UV for activities such as foraging, mate selection and navigation.

The use of vehicle-mounted lights in managing the interaction of animals and vehicles has been disclosed. For example, Philiben et al., U.S. Pat. No. 6,940,424 B2 US 2003/009031 A1, disclose a hazard avoidance system for a vehicle that utilizes data related to the location of a collision threat, conditions at the location of the collision threat and vehicle operating parameters to identify a potential animal hazard and select an optimal routine for illuminating a vehicle mounted light to repel the identified animal hazard. The system may utilize lights installed specifically for the hazard avoidance system or lights installed for another vehicular purpose to cause an output that is optimized to produce an avoidance response in the most likely or more serious animal threat as the vehicle moves through a constantly changing environment. The hazard avoidance system contemplates the illumination of one or more lights, including substantially monochromatic lights in the visible and the ultra-violet spectra, to produce an avoidance response in an animal that is most likely to pose a threat of collision to the vehicle.

The effectiveness of managing an interaction of an animal and an object with a source of light that is viewed directly by the animal is dependent upon the animal's fixation on the light source. For example, the efficacy of such a system is limited by the ability of the animal to observe the light as it approaches the object and to perceive the structure with which it is to interact. It may not be possible to provide a point source of light emission that is visible when an animal approaches an object from all angles of approach. In addition, the animal may not be able to perceive the object to be avoided from one or more flashing lights if the object is large, geographically dispersed or, like a transmission tower, of skeletal construction. Large arrays of light sources may be required to manage interaction with large structures such as wind turbines and power transmission and communication towers or geographically dispersed objects such as transmission lines and crops. Construction, operation and maintenance of large arrays of light sources may make directly viewed lights economically impractical and intense flashes of visible light may not be environmentally or socially acceptable in many places.

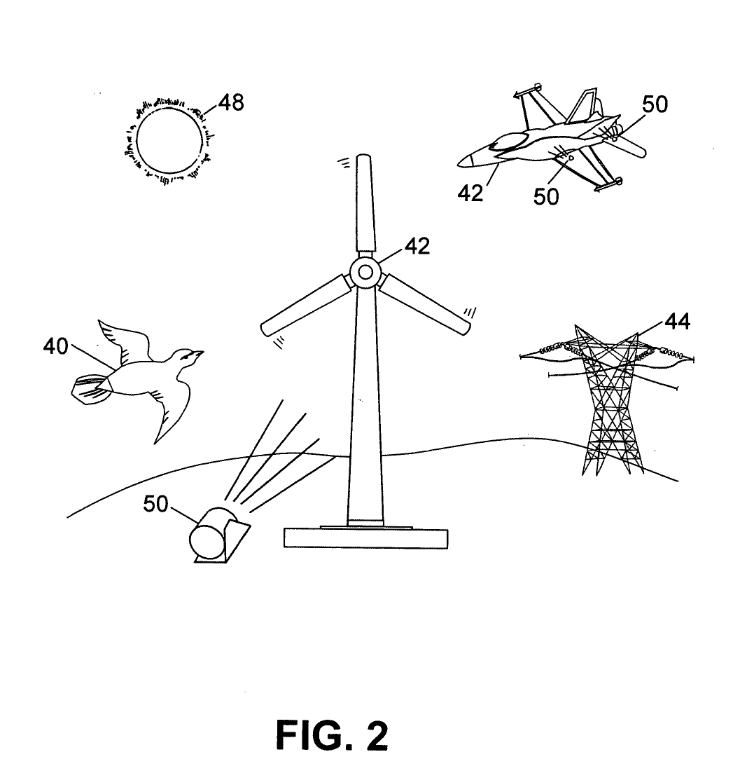

The present inventors concluded that using light to manage the interaction of animals and an object could be facilitated in many instances by incorporating the object in the visual signaling channel. More specifically, an animal may be induced to avoid an object by causing a surface of the object to selectively reflect light that includes light of one or more wavelengths known to induce a response in the animal. Since the object itself is part of the signaling channel, the technique can be used to manage interaction with objects that may be approached from many directions or are in motion, physically large, of skeletal construction, or widely dispersed. Moreover, the method can be used to supplement other methods of managing interaction between animals and objects, including methods using point sources of light emission. Referring to FIG. 2, the system for managing the interaction of an animal 40 and an object 42, 44, 46 comprises generally a source of illumination 48, 50 arranged to illuminate one or more surfaces of the object that is disposed to selectively reflect particular wavelengths of light that will stimulate the visual system and induce a response in the target animal species.

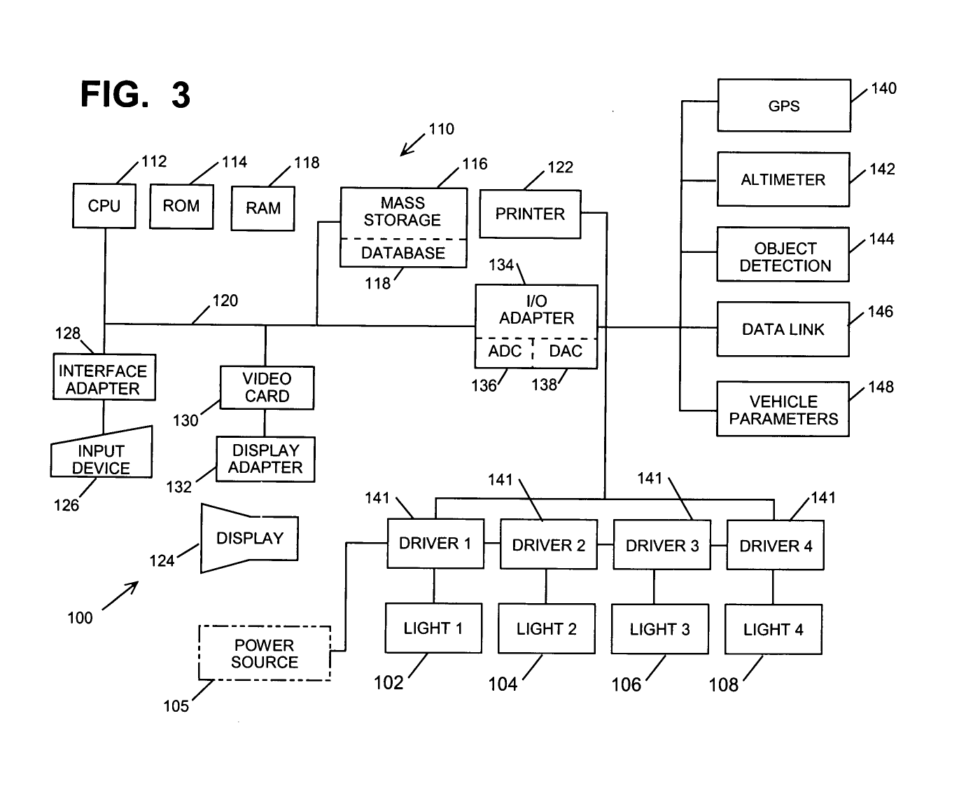

The source of illumination may be natural (e.g., the sun 48) or artificial 50 or a combination of natural and artificial light. Artificial lighting 50 may be used supplement a natural spectrum by enhancing the intensity particular wavelengths An artificial light source 50 may be also selectively energized to adapt a wavelength and intensity of the reflected light to changing environmental conditions or to anticipate changes in the species of animal expected to interact with the object. For example, artificial lighting may be used at night or to supplement natural UV radiation at dawn or dusk when UV constitutes a proportionately greater portion of natural light or to supplement natural lighting in the human visible range when climatic conditions reduce the available natural light. In addition, the output of an artificial light source 50 can be controlled to produce a pulsed or flashing reflection from the object. A light flashed with varying frequency or with variable intensity during a period of illumination between occurrences of minimal intensity may more readily attract the attention of an approaching animal or intensify the animal's response. Referring to FIG. 3, the artificial light source 50 may be adaptively operated by a control system 110 and may comprise a single source of light emissions or a plurality of light sources 102, 104, 106, 108. While the lights 102, 104, 106, 108 may include existing lights, such as position lights, landing lights, strobe lights and deicer lights of an airplane, these lights are not typically arranged for reflection from the surfaces of the vehicle.

The method for managing interaction between animals and objects may be utilized in conjunction with a wide variety of objects, including stationary objects, such as wind turbines and other structures, and movable objects, such as vehicles and movable portions of stationary structures, such wind turbine blades. Therefore, the adaptive control of artificial light sources may have many different configurations. While the block diagram of FIG. 3 depicts a control system similar to a personal computer system, the light source may be controlled by other types of data processing equipment and other devices, such as a timer, including a programmable timer, to select an appropriate source of illumination on the basis of time of day or a time of the year. The control system may be integral to an on-board computer system or may be a stand-alone system that may be capable of communicating with other computers and with a number of independent instruments and transducers providing data related to the performance and configuration of the object and conditions of the surrounding environment. The exemplary control system 110 includes a microprocessor-based, central processing unit (CPU) 112 that fetches data and instructions from a plurality of sources, processes the data according to the instructions, and stores the result or transmits the result in the form of signals to control some attached device, such as the lights 102, 104, 106, 108. Typically, basic operating instructions used by the CPU 112 are stored in nonvolatile memory or storage, such as read only memory (ROM) 114. The instructions and data used by application programs are typically stored on a nonvolatile mass storage device or memory 116, such as a disk storage unit. The data and instructions are typically transferred from the mass storage device 116 to random access memory (RAM) 118 and fetched from RAM by the CPU 112 during execution. Data and instructions are typically transferred between the CPU 112, ROM 114, and RAM 118 over an internal bus 120.

The exemplary control system 110 also includes a plurality of attached devices or peripherals, including a printer 122, a display 124, and one or more user input devices 126, such as a keyboard, mouse, or touch screen. Under the control of the CPU 112, data is transmitted to and received from each of the attached devices over a communication channel connected to the internal bus 120. Typically, each device is attached to the internal bus by way of an adapter, such as the interface adapter 128 providing an interface between the input device 126 and the internal bus 120. Likewise, a display adapter 130 provides the interface between the display 124 and the video card 132 that processes video data under the control of the CPU 112. The printer 122 and similar peripheral devices are typically connected to the internal bus 120 by one or more input-output (I/O) adapters 134.

The I/O adapter 134 commonly provides an analog-to-digital converter (ADC) 136 and a digital-to-analog converter (DAC) 138 to convert analog signals received from various transducers inputting data to the control system 110 to digital signals suitable for processing by the CPU 112 and to convert the digital signals output by the CPU to analog signals that may be required by certain peripheral equipment and device drivers 141 attached to the control system. The control system typically receives data from a number of instruments and transducers mounted on or in the vicinity of the object 22. By way examples, a vehicle-mounted control system may receive data related to the position of the vehicle from the vehicle's global positioning system 140 or other navigation system, vehicle altitude data may be received from the GPS or an altimeter 142, data related to the presence of animals may be received from an object detection system 144, such as radar, sonar, or an infrared light (IR) sensor and data related to operating parameters 148 of the vehicle or other object from a variety of transducers sensing the characteristics of the vehicle and its surroundings. Data received by the control system may also include environmental data, such as the time of day and intensity of the various wavelengths included in the ambient light. The control system 110 may also receive data concerning approaching animals from remote observers through a data link.

The control system 110 operates one or more of the light sources 102, 104, 106, 106 in accordance with a plurality of routines in an application program stored on the mass storage unit 116. The application program typically includes a database 118 relating a plurality animal identities, a plurality of environmental regimes and a plurality of light illumination routines selected to optimize a response in one or more animals that may be expected to interact with the object under the conditions of the environmental regime. A light illumination routine typically comprises an instruction, executable by the control system that identifies at least one light source to be illuminated. The illumination routine may also include an illumination pulse frequency for the identified light and may provide for varying the intensity during a period of illumination, that is, in an interval between instances of minimal intensity.

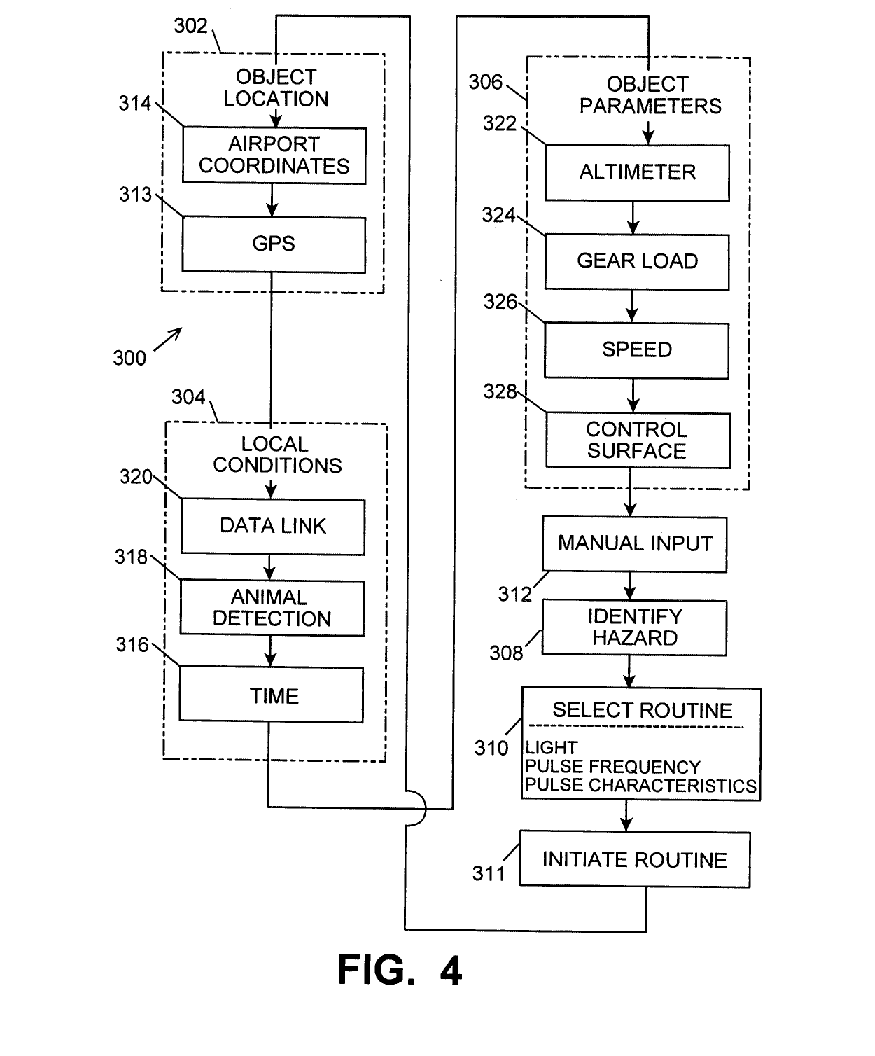

Referring to FIG. 4, a control system, such as the control system 110, typically utilizes an application program to manage interaction of an animal and an object 300. Generally, the application program for the method 300 gathers data related to a location of a potential interaction 302, conditions at the location of the potential interaction 304, and certain parameters related to the object 306 and utilizes this information to identify the animal most likely to interact with the object 308. The identity of the most likely interacting animal is used to select a surface illumination routine 310, including identification of at least one source of light for illuminating a surface of the object and, in many cases, a pulse frequency for the light source and characteristics of a light pulse for stimulating a response, such as an avoidance response, in the identified animal. The light routine is initiated 311 by the CPU 112 which signals the appropriate drivers 141 to controllably connect a power source 105, in a manner specified by the instructions of the selected routine, to appropriate lights 104-108 identified in the routine. One or more lights 104-106 can be flashed by intermittently connecting the power source 105 through the appropriate drivers 141. The intensity of the light can be varied as the pulse progresses by varying the voltage applied to the light source by the driver 141. Varying the pulse frequency of a pair of separated lights can simulate movement of a vehicle or other object and intensify the avoidance behavior of some animals. The identified animal may respond more strongly to a light pulse if the intensity of the light changes during the pulse. For example, tests indicate that brown-headed cowbirds will exhibit avoidance behavior in response to a light source with combined wavelengths of 200 nm to 2600 nm flashing alternately at a pulse frequency of 0.78 Hz.

The method periodically rechecks the location 302, local conditions 304, object parameters 306 and a manual input 312 to determine if a new hazard is to be identified 308 calling for selection 310 and initiation 311 of a different illumination routine.

The control system 110 may utilize a plurality of inputs to establish the identity of an animal 308 and select an appropriate surface illumination routine 310. For example, the control system 110 relates the identity of animals to a location of a potential interaction. The location of a potential interaction may be determined by identifying a particular airport at which an airplane is to land or from which it is to depart. For example, gulls present a significant collision hazard at airports located near bodies of water or sources of food. The coordinates of a destination or departure airport 314 can be input to the control system 110 from the vehicle's navigation system or from a global positioning system (GPS) 313. On the other hand, inputting data relating the vehicle's current location 302 from a GPS 313 or other navigation system enables the control system 110 to periodically reevaluate animal identification as the vehicle moves through different locales.

To further refine the identification of hazards, the control system 110 adjusts for local conditions at the threat's location 304. For example, the time 316, including the day and month, may influence the identification of a hazard. Diurnal birds are not likely to be a hazard at night but nocturnal birds, such as owls, and migrating birds may pose a night time hazard. Migrating animals typically pose a hazard at specific locations at particular times of the year and day. Input from an object detection system 318, such as radar, sonar, or IR sensors, may be used to identify characteristics or behaviors distinguishing species of birds or other animals. For example, certain species of birds travel in flocks and others, such as birds of prey, are more likely to be solitary or relatively few in number. The object detection system may also be able to distinguish the size of the detected animals. In addition, a data link 320 can be used to facilitate input from remote observers, such as air traffic controllers, that have observed the presence of an animal hazard, such as raptors hunting over an airfield.

The nature of a potential animal interaction may also be affected by the momentary operating conditions of the object, particularly mobile objects such as vehicles. While bird strikes during aircraft takeoff and landing are the most likely animal collision hazards, collisions with mammals, including coyotes, deer, elk, and caribou, are common and collisions with large birds, such as geese, have been reported at high altitude. The control system 110 receives input from various transducers sensing operating parameters 306 for the object to aid in the identification of the most likely hazards and selecting an surface illumination routine to optimize the response of the most likely hazards. For example, input from an aircraft's altimeter 322 can be useful in identifying the species of bird that is the most likely hazard. A landing gear loading transducer 324 can be used to determine when an airplane has left the ground and potentially hazardous species such as deer are no longer a threat.

On the other hand, data inputs from transducers measuring object parameters can be used to select a routine 310 that is not only appropriate for the animal hazard but optimized to the vehicle's operation. For example, the convergence and divergence of separated lights provide a strong visual cue to the direction and speed of a vehicle. By changing the flash rate of separated lights and the intensity of light during an illumination pulse, a high speed approach of a vehicle can be simulated, stimulating a more acute escape response by an animal posing a risk of collision. The control system 110 can utilize a vehicle speed input 326 in optimizing the flash rate and flash intensity characteristics of pulses produced by an artificial light source. Likewise, the operating parameters of the object 306 such as the position of aircraft control surfaces 328 input to the data processing system 110 by transducers or a flight control computer can be used to determine the operating mode of the vehicle and select a surface illumination routine that is appropriate for the current operating mode of the vehicle.

The control system 110 also provides for a manual input 312 through an input device 126, such as a mouse or touch screen. The manual input 312 permits the operator to identify an animal collision hazard and input the identification to the data processing system 110 for use in selecting a surface illumination routine. The control system uses various inputs relating a location of a potential animal interaction 302, conditions at the location of the potential interaction 304, operating parameters for the object 306 and manual input 312 to identify the most likely animal interactions 308 and select a surface illumination routine 310 to induce awareness and a strong response, particularly an avoidance response, in the animal most likely to interact with the object.

The surface of the object 42, 44, 46 may be painted, coated or otherwise treated to selectively reflect or absorb a particular wavelength or spectrum of the light impinging on the surface. In addition, the reflectivity of the surface may enhanced to increase the intensity of the reflected light. For example, a highly polished surface may be coated with a material that selectively absorbs light of particular wavelengths so that wavelengths providing maximum stimulation of the target animal's vision system are the predominant component of the reflected light and the intensity of the reflected light is maximized. The treatment of the surface may be uniform or patterned to produce a variegated reflection to enhance visual stimulation. Objects, such as power lines and guy wires, that have a very small surface for reflecting light may be clad or sheathed in a reflective material or structure to increase the area for reflection and the intensity of reflected light.

Since the object with which interaction is to be managed is included in the communication channel through which the visual signal is transmitted to the animal, the method can be used with structures that are physically large or skeletal in construction, such as a transmission tower 44 or guy wire. Likewise, the method can be used to manage interaction with objects that are geographically dispersed, such as power lines or crops, and objects that are in motion, such as the blades of a wind turbine or a vehicle. For example, the behavior of birds has been found to be influenced by alternating pulsing of full spectrum aircraft landing lights. Such as system might be supplemented by directing light including the same wavelengths on the rudder or another reflective surface of the aircraft or the blades of a wind turbine.

The method of managing the interaction of animals and an object incorporates the object in the communication channel through which signals are directed to the animal to enhance the animal's perception of the object, heighten the visual stimulation and induce a response by an animal, particularly the animal's avoidance response.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method for controlling interaction of an animal and an object having a surface, said method comprising the step of selectively illuminating said surface with light having a wavelength intended to induce a response by said animal.

2. The method for controlling interaction of an animal and an object of claim 1 further comprising the step of causing said surface to selectively reflect light of said wavelength inducing a response by said animal.

3. The method for controlling interaction of an animal and an object of claim 2 wherein the step of causing said surface to selectively reflect light of said wavelength inducing a response by said animal comprises the step of causing said surface to selectively absorb impinging light having a wavelength other than said wavelength inducing a response by said animal.

4. The method for controlling interaction of an animal and an object of claim 2 wherein the step of causing said surface to selectively reflect light of said wavelength inducing a response by said animal comprises the step causing said surface to selectively reflect light having a wavelength in an ultraviolet spectrum.

5. The method for controlling interaction of an animal and an object of claim 1 wherein the step of selectively illuminating said surface with light comprising a wavelength intended to induce a response by said animal comprises the step of illuminating said surface with light comprising a wavelength in an ultraviolet spectrum.

6. The method for controlling interaction of an animal and an object of claim 1 wherein the step of selectively illuminating said surface with light having a wavelength inducing a response by said animal further comprises the step of varying an intensity of illumination during an interval between occurrences of minimal intensity.

7. The method for controlling interaction of an animal and an object of claim 1 wherein the step of selectively illuminating said surface with light having a wavelength inducing a response by said animal comprises the step of illuminating said surface with light of a first wavelength at a first time and illuminating said surface with light of a second wavelength at a second time.

8. The method for controlling interaction of an animal and an object of claim 1 further comprising the step of causing a first portion of said surface to selectively reflect light of a first wavelength and a second portion of said surface to selectively reflect light of second wavelength.

9. A method for controlling interaction of an animal and an object comprising the steps of:
(a) identifying an animal potentially interacting with said object;
(b) relating said identity of said animal to a wavelength of light expected to induce a response by said identified animal; and
(c) selectively illuminating a surface of said object with light of said wavelength expected to induce said response by said identified animal.

10. The method for controlling interaction of an animal and an object of claim 9 further comprising the step of causing said surface to selectively reflect light of said wavelength expected to induce said response by said animal.

11. The method for controlling interaction of an animal and an object of claim 10 wherein the step of causing said surface to selectively reflect light of said wavelength expected to induce said response by said animal comprises the step of causing said surface to selectively absorb impinging light having a wavelength other than said wavelength expected to induce said response by said animal.

12. The method for controlling interaction of an animal and an object of claim 10 wherein the step of causing said surface to reflect light of said wavelength expected to induce said response by said animal comprises the step causing said surface to selectively reflect light having a wavelength in an ultraviolet spectrum.

13. The method for controlling interaction of an animal and an object of claim 9 wherein the step of selectively illuminating a surface of said object with light of said wavelength expected to induce said response by said identified animal comprises the step of illuminating said surface with a source of light having a wavelength in an ultraviolet spectrum.

14. The method for controlling interaction of an animal and an object of claim 9 wherein the step of selectively illuminating said surface with light of said wavelength expected to induce said response by said identified animal further comprises the step of varying an intensity of said illumination during an interval between occurrences of minimal intensity.

15. A system for controlling interaction of an animal and an object, said system comprising:
(a) a light source arranged to selectively illuminate a surface of said object, said illuminated surface of said object observable by an animal when said light source is not observable by said animal, said light source capable of emitting light having a wavelength expected to induce a response in at least one animal;
(b) data storage storing an illumination routine defining at least one of a period of minimal illumination, a period of continuous illumination at an intensity greater than an intensity of said minimal illumination, a wavelength of light, and an intensity of light; and
(c) a data processing system configured to respond to a datum specifying a location of said object by selecting an illumination routine to induce a response by an animal and operating said light source to illuminate said surface of said object according to said illumination routine.

16. The system for controlling interaction of an animal and an object of claim 15 wherein said surface is arranged to selectively reflect light of a wavelength expected to induce a response by said animal.

17. The system for controlling interaction of an animal and an object of claim 16 wherein said surface is arranged to selectively absorb impinging light having a wavelength other than said wavelength expected to induce a response by said animal.

18. The system for controlling interaction of an animal and an object of claim 16 wherein said surface is arranged to selectively reflect light having a wavelength in an ultraviolet spectrum.

19. The system for controlling interaction of an animal and an object of claim 15 wherein said light source is an emitter of light having a wavelength in an ultraviolet spectrum.

20. The system for controlling interaction of an animal and an object of claim 15 wherein said illumination routine causes said data processing system to vary an intensity of said illumination during an interval of uninterrupted illumination at an intensity greater than minimal illumination intensity, said interval of uninterrupted illumination immediately preceded by an interval of minimal illumination intensity and immediately succeeded by a consecutive second interval of minimal illumination intensity.

21. The system for controlling interaction of an animal and an object of claim 15 wherein a first portion of said surface is arranged to selectively reflect light of a first wavelength and a second portion of said surface is arranged to selectively reflect light of a second wavelength.

22. A system for controlling interaction of an animal and an object, said system comprising:
(a) a light source arranged to selectively illuminate a surface of said object, said illuminated surface of said object observable by an animal when said light source is not observable by said animal, said light source capable of emitting light having a wavelength expected to induce a response in at least one animal;
(b) data storage storing an illumination routine defining at least one of a period of minimal illumination, a period of continuous illumination at an intensity greater than an intensity of said minimal illumination, a wavelength of light, and an intensity of light; and
(c) a data processing system configured to respond to a datum specifying an operating mode of said object by selecting an illumination routine to induce a response by an animal and operating said light source to illuminate said surface of said object according to said illumination routine.

23. The system for controlling interaction of an animal and an object of claim 22 wherein said surface is arranged to selectively reflect light having a wavelength expected to induce a response by said animal.

24. The system for controlling interaction of an animal and an object of claim 22 wherein said surface is arranged to selectively absorb impinging light having a wavelength other than a wavelength expected to induce a response by said animal.

25. The system for controlling interaction of an animal and an object of claim 22 wherein a first portion of said surface is arranged to selectively reflect light of a first wavelength and a second portion of said surface is arranged to selectively reflect light of a second wavelength.

26. The system for controlling interaction of an animal and an object of claim 22 wherein said illumination routine causes said data processing system to vary an intensity of said illumination during an interval of uninterrupted illumination at an intensity greater than a minimal illumination intensity, said interval of uninterrupted illumination immediately preceded by an interval of minimal illumination intensity and immediately succeeded by a consecutive second interval of minimal illumination intensity.

27. A system for controlling interaction of an animal and an object, said system comprising:
(a) a light source arranged to selectively illuminate a surface of said object, said illuminated surface of said object observable by an animal when said light source is not observable by said animal, said light source capable of emitting light having a wavelength expected to induce a response in at least one animal;
(b) data storage storing an illumination routine defining at least one of a period of minimal illumination, a period of continuous illumination at an intensity greater than an intensity of said minimal illumination, a wavelength of light, and an intensity of light; and
(c) a data processing system configured to respond to a datum specifying at least one of a time and an environmental condition by selecting an illumination routine to induce a response by an animal and operating said light source to illuminate said surface of said object according to said illumination routine.

28. The system for controlling interaction of an animal and an object of claim 27 wherein said surface is arranged to selectively reflect light having a wavelength expected to induce a response by said animal.

29. The system for controlling interaction of an animal and an object of claim 27 wherein said surface is arranged to selectively absorb impinging light having a wavelength other than a wavelength expected to induce a response by said animal.

30. The system for controlling interaction of an animal and an object of claim 27 wherein a first portion of said surface is arranged to selectively reflect light of a first wavelength and a second portion of said surface is arranged to selectively reflect light of a second wavelength.

31. The system for controlling interaction of an animal and an object of claim 27 wherein said illumination routine causes said data processing system to vary an intensity of said illumination during an interval uninterrupted illumination between successive occurrences of minimal intensity.

32. A system for controlling interaction of an animal and an object, said system comprising:
(a) a light source arranged to selectively illuminate a surface of said object, said surface of said object observable by an animal when said light source is not observable, said light source capable of emitting light having a wavelength expected to induce a response in at least one animal;
(b) data storage storing an illumination routine defining at least one of a period of minimal illumination, a period of illumination at an intensity greater than an intensity of said minimal illumination, a wavelength of light, and an intensity of light; and
(c) a data processing system configured to respond to a datum specifying an identity of an animal by selecting an illumination routine to induce a response by an animal and operating said light source to illuminate said surface of said object according to said illumination routine.

33. The system for controlling interaction of an animal and an object of claim 32 wherein said surface is arranged to selectively reflect light having a wavelength expected to induce a response by said animal.

34. The system for controlling interaction of an animal and an object of claim 32 wherein said surface is arranged to selectively absorb impinging light having a wavelength other than a wavelength expected to induce a response by said animal.

35. The system for controlling interaction of an animal and an object of claim 32 wherein a first portion of said surface is arranged to selectively reflect light of a first wavelength and a second portion of said surface is arranged to selectively reflect light of a second wavelength.

36. The system for controlling interaction of an animal and an object of claim 32 wherein said illumination routine causes said data processing system to vary an intensity of said illumination during an interval of greater than minimal illumination intensity.
